(19) United States
(12) Patent Application Publication
(10) Pub. No.: US 2025/0388738 A1
(43) Pub. Date: Dec. 25, 2025

(54) POLYMERIZATION INHIBITOR COMPOSITION AND METHOD OF INHIBITING POLYMERIZATION OF DISTILLABLE DISILACYCLOBUTANE MONOMERS USING THE SAME

(71) Applicants: L'Air Liquide, Société Anonyme pour l'Etude et l'Exploitation des Procédés Georges Claude, Paris (FR); Air Liquide Advanced Materials, Inc., Branchburg, NJ (US)

(72) Inventors: Sean KERRIGAN, Princeton, NJ (US); Feng XU, Branchburg, NJ (US); Peng ZHANG, Montvale, NJ (US); Daniel E. EBERLY, Branchburg, NJ (US); Jean-Marc GIRARD, Versailles (FR)

(21) Appl. No.: 18/753,804

(22) Filed: Jun. 25, 2024

(51) Int. Cl. C08K 5/19; C08G 77/50

(52) U.S. Cl. CPC C08K 5/19; C08G 77/50

(57) ABSTRACT

A method for inhibiting or preventing polymerization of a polymerization composition comprises: adding at least one inhibitor(s) to the polymerization composition to stabilize and inhibit the polymerization of the polymerization composition, wherein the polymerization composition contains disilacyclobutane monomers, wherein the inhibitor is selected from amine compounds, quaternary ammonium salts or metal chelating agents.

### TECHNICAL FIELD

The present invention relates to polymerization inhibiting compositions and method of using them to inhibit polymerization of distillable disilacyclobutane monomers.

### BACKGROUND

Unintentional polymerization of relatively unstable monomers presents a challenge during synthesis, purification by distillation, storage or other manipulations. In such situations, effective polymerization inhibitors are required in order to maintain the efficient operation of manufacturing processes, storage and further manipulations of the monomer.

Mosnáček et al. disclose (Efficient Polymerization Inhibition Systems for Acrylic Acid Distillation: New Liquid-Phase Inhibitors, Industrial & Engineering Chemistry Research 2012, 51 (10), 3910-3915) an example of a monomer that is susceptible to polymerization, particularly during elevated temperatures required during distillation is acrylic acid. Consequently, inhibition systems have been developed that stabilize acrylic acid during heating.

US2022325412 discloses that substituted 1,3-disilacyclobutanes show promising utility as silicon precursor compounds that deliver low dielectric organosilicon films. Research on the development of such precursors is gaining momentum.

Rauk et al. (Theoretical study on the Ring Opening Polymerization of 1,3-Disilacyclobutanes, J. Phys. Chem. A 2012, 116, 11806-11816) and William A. Kriner (Catalytic Polymerization of 1,3-Disilacyclobutane Derivatives, Journal of Polymer Science, Part A-1, Vol 4 1966, 444-446) disclose such development is the inherent instability that 1,3-disilacyclobutanes possess. The disilacyclobutane monomers contain a strained, 4-membered ring that is favored to undergo both thermally- and catalytically-induced Ring Opening Polymerization (ROP) to form polysilylenemethylenes with a regular, head-to-tail arrangement of Silicon and Carbon in the linear backbone structure. Such instability present potential challenges during purification of the monomer by distillation, handling, transport and storage operations.

A particularly challenging problem has been the premature polymerization of the monomer during operations involving heating such as purification by distillation for example. Another such instance would be during vaporization of the liquid precursor during the process of film formation. In such events, the respective operations must be shut down followed by laborious and expensive maintenance.

Accordingly, in an effort to understand what conditions would be favorable to confer stability upon the monomer, conditions that could promote polymerization as well as those that could inhibit and prevent polymerization is demanded.

### SUMMARY

Disclosed is a method for inhibiting or preventing polymerization of a polymerization composition, the method comprising:
adding at least one inhibitor(s) to the polymerization composition to stabilize and inhibit the polymerization of the polymerization composition,
wherein the polymerization composition contains disilacyclobutane monomers,
wherein the inhibitor is selected from amine compounds, quaternary ammonium salts or metal chelating agents. The disclosed methods may include one or more of the following aspects:
the disilacyclobutane monomers being distillable disilacyclobutane monomers that have a disilacyclobutane backbone;
the distillable disilacyclobutane monomer having a particular instability;
the disilacyclobutane including two isomers, cis- and trans-disilacyclobutanes, which have particular instability and easily form polymers, as shown below.

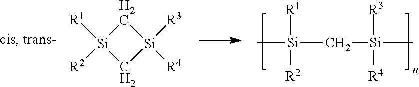

wherein R¹, R², R³ or R⁴ may be alkyl, alkoxy, dialkylamino, halogen; R¹, R², R³ and R⁴ may be same or different one from another;
the disilacyclobutane monomers being any monomers that have a disilacyclobutane backbone;
the disilacyclobutane monomers being 1,3-diethoxy-1,3-dimethyl-1,3-disilacyclobutane;
the amine compound being selected from primary, secondary and tertiary alkylamines;
the amine compound being selected from hexylamine, 2-aminohexane, 3-aminohexane heptylamine, octylamine, butylamine, pentylamine, nonylamine, decylamine tert-butylamine, diisopropylamine, 1-methylaminopropane, diethylamine and trimethylamine, cyclic amines selected from piperdine, 1,8-diazabicyclo[5.4.0]undec-7-ene, aniline, piperidine, 4-methylpiperidine, piperazine, 4-methylpiperazine, indole, pyrrolidine, 1-methylpyrrolidine pyrrole, imidazole, methylimidazole, 2-methyl-2-imidazole, 4-methylmorpholine or pyridine, aromatic amines selected from aniline, N-methylaniline, 2,4-dimethylaniline, or 4,4′-Methylenedianiline;
the quaternary ammonium salt being selected from cetrimonium bromide, cetrimonium chloride, benzalkonium cetalkonium chloride, alkyldimethylbenzyl ammonium chloride, didecyldimethyl ammonium chloride, octylydecyldimethyl ammonium chloride, N-alkyl dimethyl ethyl benzyl ammonium chloride or cetylpyridinium chloride;
the metal chelating agents being selected from ethylenediaminetetraacetic acid (EDTA), ethylene glycol-bis-(2-aminoethyl)-N,N,N′,N′-tetraacetic acid (EGTA), 2,2-bipyridyl, n-hydroxyethylethylenediaminetriacetic acid (HEDTA) or triethanolamine;
the at least one inhibitor(s) being selected from tert-butylamine, cetrimonium chloride, diisopropylamine, triethylamine, pyridine or 1,8-diazabicyclo 5.4.0undec-7-ene;
the polymerization composition comprising approximately 20 ppm to approximately 10 wt. % of the at least one inhibitor(s);
the at least one inhibitor(s) being added to the polymerization composition at a temperature ranging from room temperature (approximately 20° C. to approximately 25° C.) to approximately 200° C.;
the at least one inhibitor(s) being added to the polymerization composition at a temperature ranging from room temperature to approximately 150° C.;
the at least one inhibitor(s) being added to the polymerization composition in an inert environment, wherein the inert gas is selected from He, Ar, Kr, Xe, N₂, or combinations thereof;
the at least one inhibitor(s) being added to the polymerization composition at a pressure ranging from approximately 0 to approximately 20 psig.

Also, disclosed is a polymerization inhibiting composition comprising:
a polymerization composition containing disilacyclobutane monomers; and
an inhibitor configured to stabilize and inhibit polymerization of the disilacyclobutane monomers, wherein the inhibitor is selected from amine compounds, quaternary ammonium salts or metal chelating agents. The disclosed method may include one or more of the following aspects:
the amine compound being selected from primary, secondary and tertiary alkylamines;
the amine compound being selected from butylamine, pentylamine, hexylamine, 2-aminohexane, 3-aminohexane heptylamine, octylamine, nonylamine, decylamine tert-butylamine, diisopropylamine, 1-methylaminopropane, diethylamine and trimethylamine, cyclic amines selected from piperdine, 1,8-diazabicyclo[5.4.0]undec-7-ene, aniline, piperidine, 4-methylpiperidine, piperazine, 4-methylpiperazine, indole, pyrrolidine, 1-methylpyrrolidine pyrrole, imidazole, methylimidazole, 2-methyl-2-imidazole, 4-methylmorpholine or pyridine, aromatic amines selected from aniline, N-methylaniline, 2,4-dimethylaniline, or 4,4′-Methylenedianiline;
the quaternary ammonium salt being selected from cetrimonium bromide, cetrimonium chloride, benzalkonium chloride, cetalkonium chloride, alkyldimethylbenzyl ammonium chloride, didecyldimethyl ammonium chloride, octylydecyldimethyl ammonium chloride, N-alkyl dimethyl ethyl benzyl ammonium chloride or cetylpyridinium chloride;
the metal chelating agents being selected from ethylenediaminetetraacetic acid (EDTA), ethylene glycol-bis-(2-aminoethyl)-N,N,N′,N′-tetraacetic acid (EGTA), 2,2-bipyridyl, n-hydroxyethylethylenediaminetriacetic acid (HEDTA) or triethanolamine;
the distillable disilacyclobutane monomers being 1,3-diethoxy-1,3-dimethyl-1,3-disilacyclobutane; and
the polymerization composition comprising approximately 20 ppm to approximately 10 wt. % of the at least one inhibitor(s).

### NOTATION AND NOMENCLATURE

The following detailed description and claims utilize a number of abbreviations, symbols, and terms, which are generally well known in the art. Certain abbreviations, symbols, and terms are used throughout the following description and claims, and include:

As used herein, the indefinite article “a” or “an” means one or more.

As used herein, “about” or “around” or “approximately” in the text or in a claim means ±10% of the value stated.

As used herein, “room temperature” in the text or in a claim means from approximately 20° C. to approximately 25° C.

The term “ambient temperature” refers to an environment temperature approximately 20° C. to approximately 25° C.

As used herein, “inhibiting” includes both inhibiting and preventing the formation and agglomeration of polymerization.

As used herein, the term “inhibitor” refers to a molecule that inhibits the formation and agglomeration of polymerization.

As used herein, the term “additive” refers to a molecule that's usually added to a deposition or etching composition to make it more efficient.

Note that herein, the terms “precursor” and “deposition compound” and “deposition gas” may be used interchangeably when the precursor is in a gaseous state at room temperature and ambient pressure. It is understood that a precursor may correspond to, or be related to a deposition compound or deposition gas, and that the deposition compound or deposition gas may refer to the precursor.

The standard abbreviations of the elements from the periodic table of elements are used herein. It should be understood that elements may be referred to by these abbreviation (e.g., Si refers to silicon, N refers to nitrogen, O refers to oxygen, C refers to carbon, H refers to hydrogen, F refers to fluorine, etc.).

The unique CAS registry numbers (i.e., “CAS”) assigned by the Chemical Abstract Service are provided to identify the specific molecules disclosed.

As used herein, the abbreviation “Me” refers to a methyl group; the abbreviation “Et” refers to an ethyl group; the abbreviation “Pr” refers to any propyl group (i.e., n-propyl or isopropyl); the abbreviation “iPr” refers to an isopropyl group; the abbreviation “Bu” refers to any butyl group (n-butyl, iso-butyl, tert-butyl, sec-butyl); the abbreviation “tBu” refers to a tert-butyl group; the abbreviation “sBu” refers to a sec-butyl group; the abbreviation “iBu” refers to an iso-butyl group; the abbreviation “Ph” refers to a phenyl group; the abbreviation “Am” refers to any amyl group (iso-amyl, sec-amyl, tert-amyl); the abbreviation “Cy” refers to a cyclic hydrocarbon group (cyclobutyl, cyclopentyl, cyclohexyl, etc.); the abbreviation “Ar” refers to an aromatic hydrocarbon group (phenyl, xylyl, mesityl, etc.).

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

Optional or optionally means that the subsequently described event or circumstances may or may not occur. The description includes instances where the event or circumstance occurs and instances where it does not occur.

Reference herein to “one embodiment” or “an embodiment” means that a particular feature, structure, or characteristic described in connection with the embodiment may be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used herein, the term “independently” when used in the context of describing R groups should be understood to denote that the subject R group is not only independently selected relative to other R groups bearing the same or different subscripts or superscripts, but is also independently selected relative to any additional species of that same R group. For example in the formula MR¹ₓ(NR²R³)₍₄₋ₓ₎, where x is 2 or 3, the two or three R¹ groups may, but need not be identical to each other or to R² or to R³. Further, it should be understood that unless specifically stated otherwise, values of R groups are independent of each other when used in different formulas.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

“Comprising” in a claim is an open transitional term which means the subsequently identified claim elements are a nonexclusive listing (i.e., anything else may be additionally included and remain within the scope of “comprising”). “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actors in the absence of express language in the claim to the contrary.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is 29Si NMR for the 1,3-Diethoxy-1,3-dimethyl-1,3-disilacyclobutane polymer without additives in accordance with an exemplary embodiment of the present invention;

FIG. 2 is 29Si NMR for the 1,3-Diethoxy-1,3-dimethyl-1,3-disilacyclobutane polymer with tert-butylamine 1 wt. % additive in accordance with an exemplary embodiment of the present invention;

FIG. 3 is 29Si NMR for the 1,3-Diethoxy-1,3-dimethyl-1,3-disilacyclobutane polymer with cetrimonium chloride 1 wt. % additive in accordance with an exemplary embodiment of the present invention;

FIG. 4 is 29Si NMR for the 1,3-Diethoxy-1,3-dimethyl-1,3-disilacyclobutane polymer with Diisopropylamine 1 wt. % additive in accordance with an exemplary embodiment of the present invention;

FIG. 5 is 29Si NMR for the 1,3-Diethoxy-1,3-dimethyl-1,3-disilacyclobutane polymer with Triethylamine 1 wt. % additive in accordance with an exemplary embodiment of the present invention;

FIG. 6 is 29Si NMR for the 1,3-Diethoxy-1,3-dimethyl-1,3-disilacyclobutane polymer with Pyridine 1 wt. % additive in accordance with an exemplary embodiment of the present invention; and

FIG. 7 is 29Si NMR for the 1,3-Diethoxy-1,3-dimethyl-1,3-disilacyclobutane polymer with 1,8-Diazabicyclo 5.4.0undec-7-ene 1 wt. % additive in accordance with an exemplary embodiment of the present invention.

### DESCRIPTION OF PREFERRED EMBODIMENTS

Disclosed are polymerization inhibiting compositions and method of inhibiting polymerization of distillable disilacyclobutane monomers. More specifically, certain additives inhibit the polymerization of the distillable disilacyclobutane monomers. Such additives are also called inhibitors.

The disclosed distillable disilacyclobutane monomers that contain a strained, 4-membered ring are suitable for using as a silicon precursor that may generate low dielectric organosilicon films. The disclosed distillable disilacyclobutane monomer has a particular instability that shows in the Examples that follow.

Disilacyclobutane monomers includes two isomers, cis- and trans-disilacyclobutanes, which have particular instability and easily form polymers, as shown below.

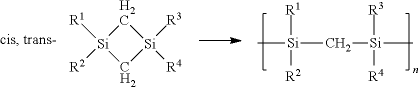

wherein R¹, R², R³ or R⁴ may be alkyl, alkoxy, dialkylamino, halogen; R¹, R², R³ and R⁴ may be same or different one from another.

The disclosed distillable disilacyclobutane monomers may be any monomers that have a disilacyclobutane backbone.

The disclosed distillable disilacyclobutane monomers may be 1,3-diethoxy-1,3-dimethyl-1,3-disilacyclobutane.

The additives may be sufficiently non-volatile to remain in the distillation boiler pot with the distillable monomer, therefore, acting as a “captive polymerization inhibitor.” Conversely, the additives may be sufficiently volatile to be distillable with the monomer, therefore, acting as a “fugitive polymerization inhibitor.” Such polymerization inhibitors may be added to purified monomer to inhibit polymerization during storage and transport, yet have sufficient volatility to not impact film composition during deposition processes.

The disclosed at least one additive in the polymerization inhibiting compositions may be selected from amines, quaternary ammonium salts or metal chelating agents.

It has been found that disclosed amine compounds herein may stabilize and inhibit polymerization of disilacyclobutanes. Examples of the disclosed amine compounds include but are not limited to primary, secondary and tertiary alkylamines including but not limited to butylamine, pentylamine, hexylamine, 2-aminohexane, 3-aminohexane heptylamine, octylamine, nonylamine, decylamine tert-butylamine, diisopropylamine, 1-methylaminopropane, diethylamine and triethylamine. Cyclic amines including but not limited to piperdine, 1,8-Diazabicyclo[5.4.0]undec-7-ene, aniline, piperidine, 4-methylpiperidine, piperazine, 4-methylpiperazine, indole, pyrrolidine, 1-methylpyrrolidine pyrrole, imidazole, methylimidazole, 2-methyl-2-imidazole, 4-methylmorpholine and pyridine. Aromatic amines including but not limited to aniline, N-methylaniline, 2,4-Dimethylaniline, 4,4′-Methylenedianiline. The disclosed amine compound is tert-butylamine.

It has been found that disclosed quaternary ammonium salts herein may stabilize and inhibit polymerization of disilacyclobutanes. Examples of the disclosed quaternary ammonium salts include but are not limited to cetrimonium bromide, cetrimonium chloride, benzalkonium chloride, cetalkonium chloride, alkyldimethylbenzyl ammonium chloride, didecyldimethyl ammonium chloride, octylydecyldimethyl ammonium chloride, N-alkyl dimethyl ethyl benzyl ammonium chloride and cetylpyridinium chloride. The disclosed quaternary ammonium salt is cetrimonium chloride.

It has been found that disclosed metal chelating agents may stabilize and inhibit polymerization of disilacyclobutanes. Examples of the disclosed metal chelating agents include but are not limited to Ethylenediaminetetraacetic acid (EDTA), Ethylene glycol-bis-(2-aminoethyl)-N,N,N′,N′-tetraacetic acid (EGTA), 2,2-Bipyridyl, n-hydroxyethylethylenediaminetriacetic acid (HEDTA) and triethanolamine.

The disclosed polymerization inhibiting compositions may comprise 20 ppm to about 10 wt. % of at least one additive from any of the compounds listed above. The disclosed additive or inhibitor may be added to the distillable disilacyclobutane monomers in a temperature ranging from room temperature (approximately 20° C. to approximately 25° C.) to approximately 200° C., preferably from room temperature to approximately 150° C.

An inert environment may be beneficial for the polymerization inhibiting compositions containing at least one above additive. The inert gas is selected from He, Ar, Kr, Xe, N₂, or combinations thereof.

The preferred reaction pressure range is about from 0 to 20 psig.

The disclosed synthesis methods may be scaled up to produce a large amount of the product. For example, scaled up to approximately 1 kg to approximately 100 kg.

### EXAMPLES

The following non-limiting examples are provided to further illustrate embodiments of the invention. However, the examples are not intended to be all inclusive and are not intended to limit the scope of the inventions described herein.

### Example 1: Without Adding Additives

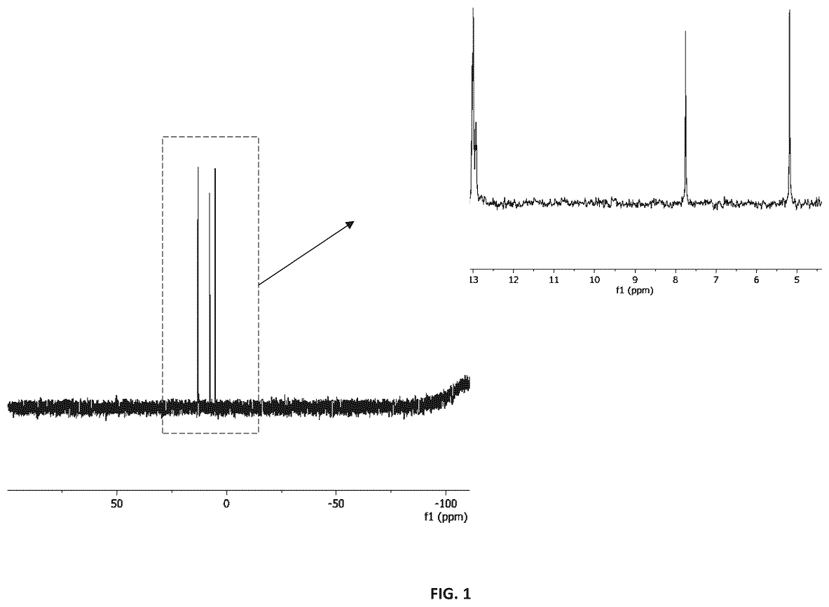

An oven-dried glass pressure tube (25 mL) was charged with 1,3-Diethoxy-1,3-dimethyl-1,3-disilacyclobutane (10 g) in a nitrogen atmosphere glove box and then sealed with a teflon plug. The tube and contents were removed from the glove box and heated to 150° C. After 24 h, upon visual inspection the disilacyclobutane had polymerized forming a solid gel. Analysis by 29Si NMR was consistent with a mixture of the starting monomer and polymerized material as shown in FIG. 1.

### Example 2: Adding Additive Tert-Butylamine 1 wt. %

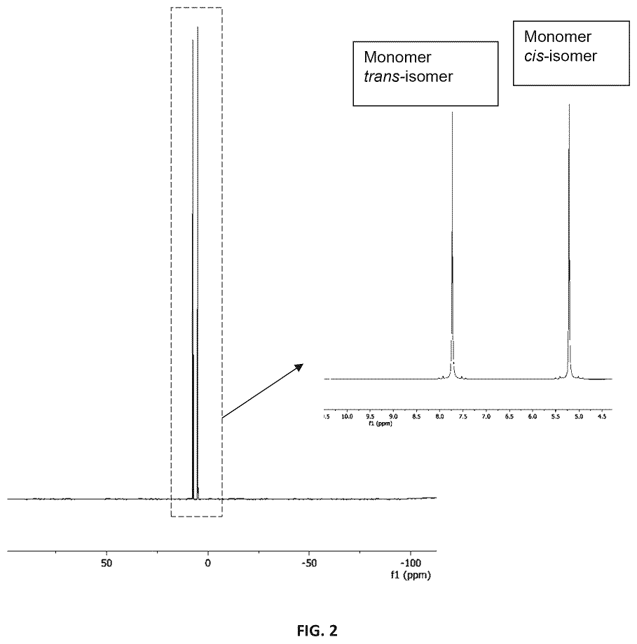

An oven-dried glass pressure tube (25 mL) was charged with 1,3-Diethoxy-1,3-dimethyl-1,3-disilacyclobutane (10 g) and tert-butylamine (1 wt. %) in a nitrogen atmosphere glove box and then sealed with a teflon plug. The tube and contents were removed from the glove box and heated to 150° C. After 28 days no change was observed by visual inspection and analysis by 29Si NMR confirmed the material to be consistent with the starting monomer and no polymeric material, as shown in FIG. 2.

### Example 3: Adding Additive Cetrimonium Chloride 1 wt. %

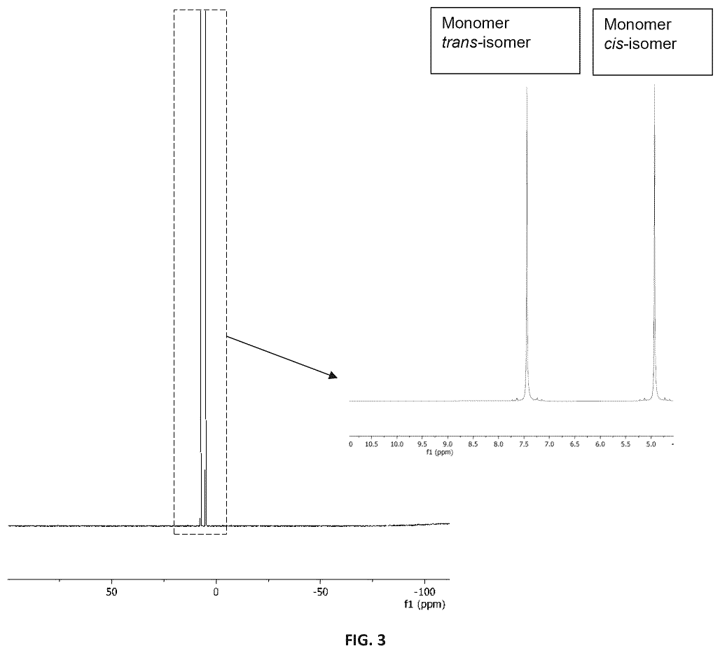

An oven-dried glass pressure tube (25 mL) was charged with 1,3-Diethoxy-1,3-dimethyl-1,3-disilacyclobutane (10 g) and cetrimonium chloride (1 wt. %) in a nitrogen atmosphere glove box and then sealed with a teflon plug. The tube and contents were removed from the glove box and heated to 150° C. After 14 days no change was observed by visual inspection and analysis by 29Si NMR confirmed the material to be consistent with the starting monomer and no polymeric material, as shown in FIG. 3.

### Example 4: Adding Additive Diisopropylamine 1 wt. %

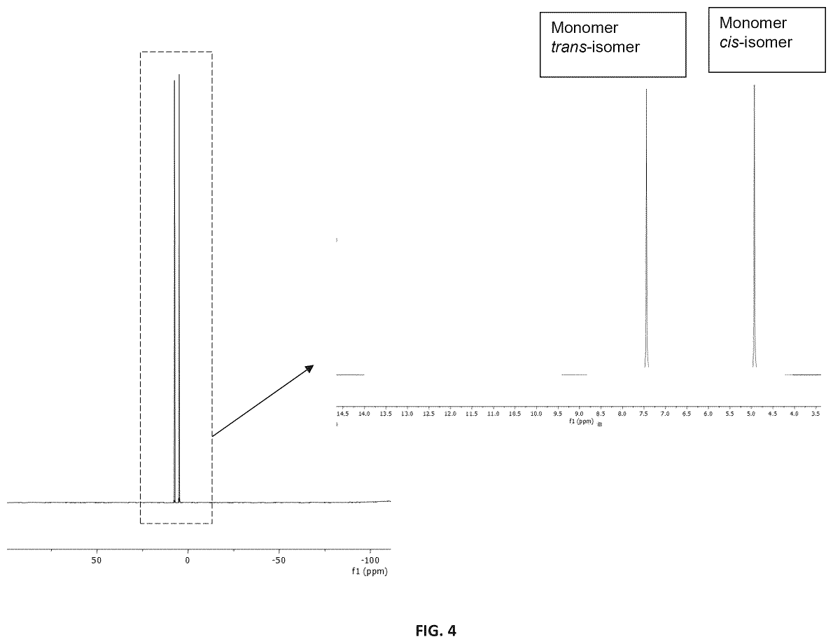

An oven-dried glass pressure tube (25 mL) was charged with 1,3-Diethoxy-1,3-dimethyl-1,3-disilacyclobutane (10 g) and diisopropylamine (1 wt. %) in a nitrogen atmosphere glove box and then sealed with a teflon plug. The tube and contents were removed from the glove box and heated to 150° C. After 28 days no change was observed by visual inspection and analysis by 29Si NMR confirmed the material to be consistent with the starting monomer and no polymeric material, as shown in FIG. 4.

### Example 5: Adding Additive Triethylamine 1 wt. %

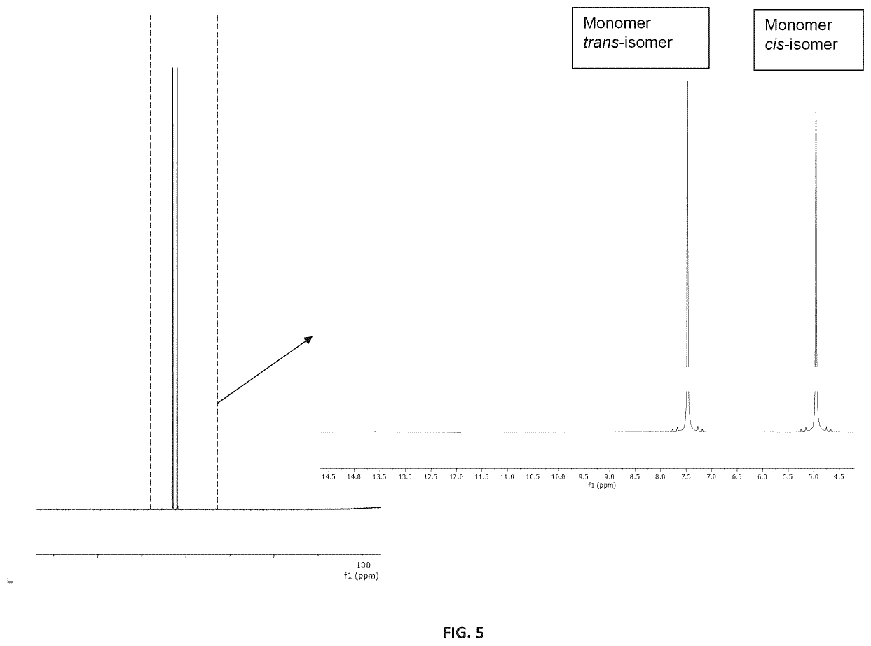

An oven-dried glass pressure tube (25 mL) was charged with 1,3-Diethoxy-1,3-dimethyl-1,3-disilacyclobutane (10 g) and triethylamine (1 wt. %) in a nitrogen atmosphere glove box and then sealed with a teflon plug. The tube and contents were removed from the glove box and heated to 150° C. After 28 days no change was observed by visual inspection and analysis by 29Si NMR confirmed the material to be consistent with the starting monomer and no polymeric material, as shown in FIG. 5.

### Example 6: Adding Additive Pyridine 1 wt. %

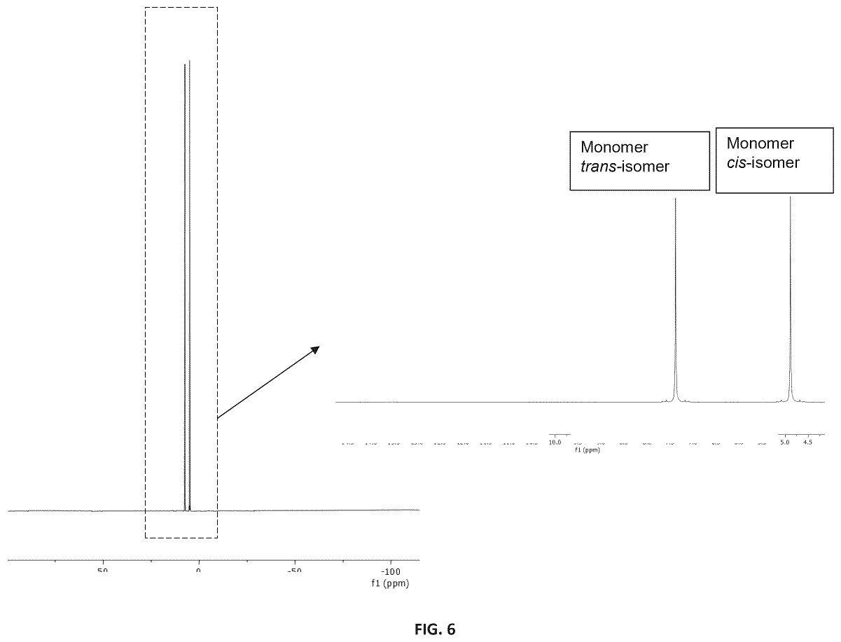

An oven-dried glass pressure tube (25 mL) was charged with 1,3-Diethoxy-1,3-dimethyl-1,3-disilacyclobutane (10 g) and pyridine (1 wt. %) in a nitrogen atmosphere glove box and then sealed with a teflon plug. The tube and contents were removed from the glove box and heated to 150° C. After 28 days no change was observed by visual inspection and analysis by 29Si NMR confirmed the material to be consistent with the starting monomer and no polymeric material, as shown in FIG. 6.

### Example 7: Adding Additive 1,8-Diazabicyclo 5.4.0undec-7-ene 1 wt. %

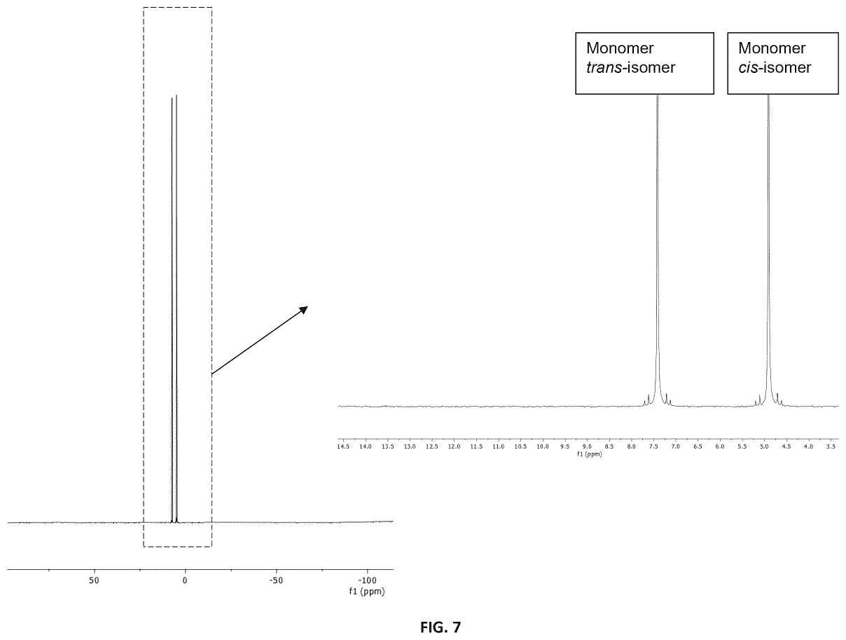

An oven-dried glass pressure tube (25 mL) was charged with 1,3-Diethoxy-1,3-dimethyl-1,3-disilacyclobutane (10 g) and 1,8-Diazabicyclo 5.4.0undec-7-ene (1 wt. %) in a nitrogen atmosphere glove box and then sealed with a teflon plug. The tube and contents were removed from the glove box and heated to 150° C. After 28 days no change was observed by visual inspection and analysis by 29Si NMR confirmed the material to be consistent with the starting monomer and no polymeric material, as shown in FIG. 7.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

We claim:

1. A method for inhibiting or preventing polymerization of a polymerization composition, the method comprising:
adding at least one inhibitor(s) to the polymerization composition to stabilize and inhibit the polymerization of the polymerization composition,
wherein the polymerization composition contains disilacyclobutane monomers,
wherein the inhibitor is selected from amine compounds, quaternary ammonium salts or metal chelating agents.

2. The method of claim 1, wherein the disilacyclobutane monomers are distillable disilacyclobutane monomers that have a disilacyclobutane backbone.

3. The method of claim 1, wherein the disilacyclobutane monomers is 1,3-diethoxy-1,3-dimethyl-1,3-disilacyclobutane.

4. The method of claim 1, wherein the amine compound is selected from primary, secondary and tertiary alkylamines.

5. The method of claim 4, wherein the amine compound is selected from butylamine, pentylamine, hexylamine, 2-aminohexane, 3-aminohexane heptylamine, octylamine, nonylamine, decylamine tert-butylamine, diisopropylamine, 1-methylaminopropane, diethylamine and trimethylamine, cyclic amines selected from piperdine, 1,8-diazabicyclo[5.4.0]undec-7-ene, aniline, piperidine, 4-methylpiperidine, piperazine, 4-methylpiperazine, indole, pyrrolidine, 1-methylpyrrolidine pyrrole, imidazole, methylimidazole, 2-methyl-2-imidazole, 4-methylmorpholine or pyridine, aromatic amines selected from aniline, N-methylaniline, 2,4-dimethylaniline, or 4,4′-Methylenedianiline.

6. The method of claim 1, wherein the quaternary ammonium salt is selected from cetrimonium bromide, cetrimonium chloride, benzalkonium chloride, cetalkonium chloride, alkyldimethylbenzyl ammonium chloride, didecyldimethyl ammonium chloride, octylydecyldimethyl ammonium chloride, N-alkyl dimethyl ethyl benzyl ammonium chloride or cetylpyridinium chloride.

7. The method of claim 1, wherein the metal chelating agents is selected from ethylenediaminetetraacetic acid (EDTA), ethylene glycol-bis-(2-aminoethyl)-N,N,N′,N′-tetraacetic acid (EGTA), 2,2-bipyridyl, n-hydroxyethylethylenediaminetriacetic acid (HEDTA) or triethanolamine.

8. The method of claim 1, wherein the at least one inhibitor(s) is selected from tert-butylamine, cetrimonium chloride, diisopropylamine, triethylamine, pyridine or 1,8-diazabicyclo 5.4.0undec-7-ene.

9. The method of claim 1, wherein the polymerization composition comprises approximately 20 ppm to approximately 10 wt. % of the at least one inhibitor(s).

10. The method of claim 1, wherein the at least one inhibitor(s) is added to the polymerization composition at a temperature ranging from room temperature (approximately 20° C. to approximately 25° C.) to approximately 200° C.

11. The method of claim 1, wherein the at least one inhibitor(s) is added to the polymerization composition at a temperature ranging from room temperature to approximately 150° C.

12. The method of claim 1, wherein the at least one inhibitor(s) is added to the polymerization composition in an inert environment, wherein the inert gas is selected from He, Ar, Kr, Xe, N₂, or combinations thereof.

13. The method of claim 1, wherein the at least one inhibitor(s) is added to the polymerization composition at a pressure ranging from approximately 0 to approximately 20 psig.

14. A polymerization inhibiting composition comprising:
a polymerization composition containing disilacyclobutane monomers; and
an inhibitor configured to stabilize and inhibit polymerization of the disilacyclobutane monomers, wherein the inhibitor is selected from amine compounds, quaternary ammonium salts or metal chelating agents.

15. The polymerization inhibitor composition of claim 14, wherein the amine compound is selected from primary, secondary and tertiary alkylamines.

16. The polymerization inhibitor composition of claim 15, wherein the amine compound is selected from butylamine, pentylamine, hexylamine, 2-aminohexane, 3-aminohexane heptylamine, octylamine, nonylamine, decylamine tert-butylamine, diisopropylamine, 1-methylaminopropane, diethylamine and trimethylamine, cyclic amines selected from piperdine, 1,8-diazabicyclo[5.4.0]undec-7-ene, aniline, piperidine, 4-methylpiperidine, piperazine, 4-methylpiperazine, indole, pyrrolidine, 1-methylpyrrolidine pyrrole, imidazole, methylimidazole, 2-methyl-2-imidazole, 4-methylmorpholine or pyridine, aromatic amines selected from aniline, N-methylaniline, 2,4-dimethylaniline, or 4,4′-Methylenedianiline.

17. The polymerization inhibitor composition of claim 14, wherein the quaternary ammonium salt is selected from cetrimonium bromide, cetrimonium chloride, benzalkonium chloride, cetalkonium chloride, alkyldimethylbenzyl ammonium chloride, didecyldimethyl ammonium chloride, octylydecyldimethyl ammonium chloride, N-alkyl dimethyl ethyl benzyl ammonium chloride or cetylpyridinium chloride.

18. The polymerization inhibitor composition of claim 14, wherein the metal chelating agents is selected from ethylenediaminetetraacetic acid (EDTA), ethylene glycol-bis-(2-aminoethyl)-N,N,N′,N′-tetraacetic acid (EGTA), 2,2-bipyridyl, n-hydroxyethylethylenediaminetriacetic acid (HEDTA) or triethanolamine.

19. The polymerization inhibitor composition of claim 14, wherein the distillable disilacyclobutane monomers is 1,3-diethoxy-1,3-dimethyl-1,3-disilacyclobutane.

20. The polymerization inhibitor composition of claim 14, wherein the polymerization composition comprises approximately 20 ppm to approximately 10 wt. % of the at least one inhibitor(s).
